(19) United States
(12) Patent Application Publication
(10) Pub. No.: US 2006/0075347 A1
(43) Pub. Date: Apr. 6, 2006

(54) Computerized notetaking system and method

(76) Inventor: Peter H. Rehm, Orem, UT (US)

Correspondence Address: Peter H. Rehm, 115 E 900 S, Orem, UT, 84058, US

(21) Appl. No.: 11/243,589

(22) Filed: Oct. 4, 2005

Related U.S. Application Data
(60) Provisional application No. 60/616,343, filed on Oct. 5, 2004.

(51) Int. Cl. G06F 3/00

(52) U.S. Cl. 715/727; 715/732

(57) ABSTRACT

A computerized notetaking system that records audio and links notes to the audio and has enhancements such as: Always-on audio recording and external timestamp button that work even when the system is turned off. A “next-topic” command that prepares and timestamps a new paragraph while allowing the user to complete the current paragraph. Commands for creating callouts and sidebar boxes in the user notes. A choice of audio filters. Speech recognition for searching through and navigating an audio recording. Speech recognition accuracy enhancement based upon typed notes. Playback, including lockstep playback, that prefers starting and stopping at word boundaries without overlap when possible. A self-adjusting preplay parameter. A “repeat slower” command that replays a few seconds of audio and then resumes at normal speed. Integrated background audio that plays music or white noise when notes-related audio is not being played. Several other enhancements are disclosed.

### CROSS-REFERENCE TO RELATED APPLICATION

This application claims the benefit of U.S. provisional patent application Ser. No. 60/616,343, filed Oct. 5, 2004.

### BACKGROUND OF THE INVENTION

There is increasing interest in using computers to take notes in classrooms, meetings and other occasions where notes are taken. Sometimes people use an ordinary word processor on a notebook computer to take notes. However, word processors are primarily document formatting tools. The many formatting options can actually get in the way when trying to hastily enter notes in real time. On the other hand, ordinary word processors do not include enhancements that would be of use when taking notes in classrooms and meetings.

Several inventions and products have been proposed for field use. Some proposed products are for use primarily on a tablet style portable computer, other on notebook or laptop computers, others in personal digital assistants (PDA's), others use special paper and ink pens that are capable of easily transferring notes to a computer later, still others are intended to be permanently installed in meeting rooms.

While these products may be used to successfully take notes on a computer, there is still much room for improving the user experience. A better user experience will increase the number of people who take notes on the various kinds of computing devices and will increase the number of people who actually use the special note-taking features. This will have the effect of improving the quality of the notes that are taken.

### OBJECTS AND SUMMARY

The overall object of the current invention is to improve the user experience when taking notes with a computing device that links the notes to an audio recording. The user experience is improved by providing refinements that remove distractions and help users accomplish their objectives. The invention accomplishes its objectives by having as some or many of the following features:

The invention can be provided with an external timestamping button on it. This button allows a user to create a timestamp in some notes even when the invention is in use for taking notes. The invention can also be provided with an always-on recording feature. This feature means that it is always recording audio, even when it is not in use for taking notes. The audio may be retained for a preset time is extended if there is a timestamp associated with the audio. This makes the invention useful for capturing and retaining audio starting from a point prior to when the user knew it was important, even when the invention is turned off.

As the user is entering notes during an event (e.g. a speech), the user will likely be lagging somewhat behind the speaker. When the speaker changes topics, the user can issue a “next-topic” command. The next-topic command causes the invention to immediately prepare a timestamped paragraph for the next topic's notes while allowing the user to finish the previous topic before starting to add notes there. In case topics change very quickly and multiple next-topic commands are issued, the invention can optionally prompt for a topic label so that each new paragraph is clearly labeled with its topic.

A “create callout” command lets the user momentarily interrupt the normal entry of notes to annotate previously entered notes. This is done by creating a callout, typing the explanatory text and returning the normal entry of notes.

A “create sidebar box” command lets the user enter notes in an automatically created sidebar box.

When the notes-related audio recording is played, the user is presented with a choice of audio filters that can make the audio more understandable.

The invention uses speech recognition to provides a convenient way of searching and navigating through the audio recording. Automatically recognized text is displayed and can be used to follow links into the audio. Automatically recognized text is useful even if the speech recognition engine is only fifty percent accurate. Nevertheless the accuracy of the speech recognition engine is enhanced by favoring words found in the notes as more likely translates of the audio.

When the user directs the invention to play the audio recording starting at a particular point, the invention attempts to start the play of audio at a word boundary rather than in the middle of a word. It does this by looking for short pauses or other evidence of word boundaries in the audio near that particular point. If it finds something then it starts the recording at that nearby point instead. It also attempts to stop the audio at a word boundary.

When using a transcription feature called lockstep playback, the invention plays the audio in a series of short segments. Normally these segments overlap, but when the invention can find a suitable stopping point between words, lockstep playback proceeds without overlap.

As a users uses the invention, it “breaks in” according to the users unique manner of using it. It does this by automatically adjusting its “preplay” parameter. The preplay parameter is the amount of recorded audio to be played leading up to a timestamp. Its purpose is to compensate for the user's reaction time between hearing something important and starting to take notes on it. The adjustment is made when the user routinely rewinds or fast forwards the audio after playing the audio from a timestamp. For example, if the user routinely rewinds after clicking on an audio link, then the preplay parameter is gradually increased.

The user can control further control the audio playback using a scrolling wheel. The scrolling wheel is used to rewind or fast forward (both with audio), and/or to change the speed of playback.

A “repeat slower” command enables the user to issue just one command to replay a few seconds of audio at a slower speed, and then resume listening at normal speed. This is useful whenever the user does not understand something in the audio and wants to quickly try again without slowing down the entire playback. It also has the effect of encouraging users to set playback speed a little higher than they otherwise would.

Use of the invention is encouraged by the invention's integrated background audio feature. This lets the user listen to background music, sounds of nature or even white noise when not listing to any notes-related recording. When listening to notes-related recording, the background audio may be paused, muted or reduced in volume, according to the user's choice.

### BRIEF DESCRIPTION OF THE DRAWINGS

FIG. 1A is a perspective view of a notebook computer, one type of computing device in which the method of the present invention can be utilized.

FIG. 1B is a front view of a palm computer or personal digital assistant, another type of computing device in which the method of the present invention can be utilized.

FIG. 2 is a functional block diagram illustrating the interconnection of the hardware components of the invention.

FIG. 3 shows the main window of the invention as displayed on a computer monitor.

FIG. 4 show a detailed view of the left end of the track bar of FIG. 3.

FIGS. 5A-5C show the left end of the trackbar in even greater detail, and shows three alternative variations of the trackbar.

FIG. 6 is a schematic diagram of some speech in the time domain.

FIGS. 7A-7C show example notes before a next-topic command is given and then after each of two kinds of next-topic commands are given.

FIGS. 8A-8C show example notes before, during and after a create sidebar box command, respectively.

FIGS. 9A-9C show example notes before, during and after a create callout command, respectively.

FIG. 10 shows a popup audio control window.

### DETAILED DESCRIPTION OF THE INVENTION

The current invention builds upon and refines the “Multimedia Word Processor” disclosed in U.S. Pat. No. 6,802,041 to Rehm, the disclosure of which is hereby incorporated by reference. That patent teaches a word processor combined with a digital recorder that makes an audio recording of an event as notes are taken. The notes contain timestamps linking particular points in the notes with particular points in the recording. This can be used to conveniently correct and enhance notes that were taken in real time by allowing the user to instantly play the portion the recording that was relevant to any selected item of the notes. Because an unknown amount of delay exists between the particular audio portion of interest and the making of the notes, the Multimedia Word Processor provided for playing the recording at increased speed starting significantly earlier than the time the selected notes were entered.

The current invention is also multimedia word processor (including notetaking software and stand-alone notetaking devices) enhanced with the any combination of the following features. These features combine synergistically to create a better environment for and method of taking notes.

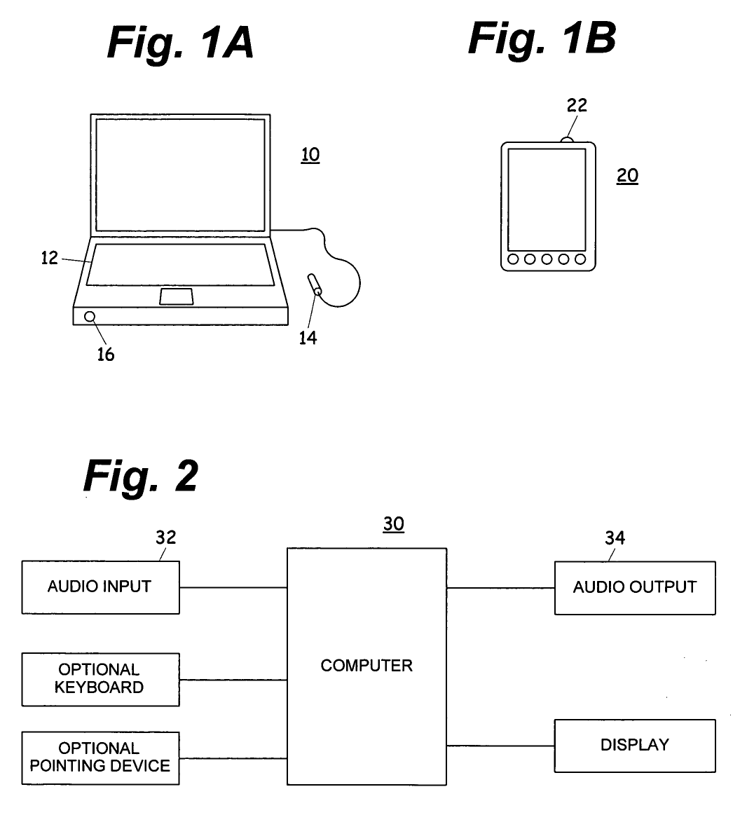

FIGS. 1A-1B show a couple of the computing devices upon which the current invention can be implemented: a notebook or laptop computer 10 and a handheld device 20 (e.g., a PDA or palm computer, perhaps with cell phone capability). The current invention can be implemented on desktop and tablet computers as well. In addition, it may be implemented as a dedicated notetaking device or other device that can accept notes and make an audio or video recording. It is most likely to find use in the portable computing devices. The current invention can be implemented with both keyboard input or pen input (meaning an electronically detected stylus), or both of them. It also benefits from the ability to accept still digital photographs, which can often exceed the resolution of video.

FIG. 2 is a block diagram 30 showing the various parts of the invention. The audio input 32 need not be connected to the computer all the time. It may be a microphone 14 or the audio may be recorded by an external device and made available later. The audio output 34 may be a speaker or earphones, etc., and need only be connected when actually in use.

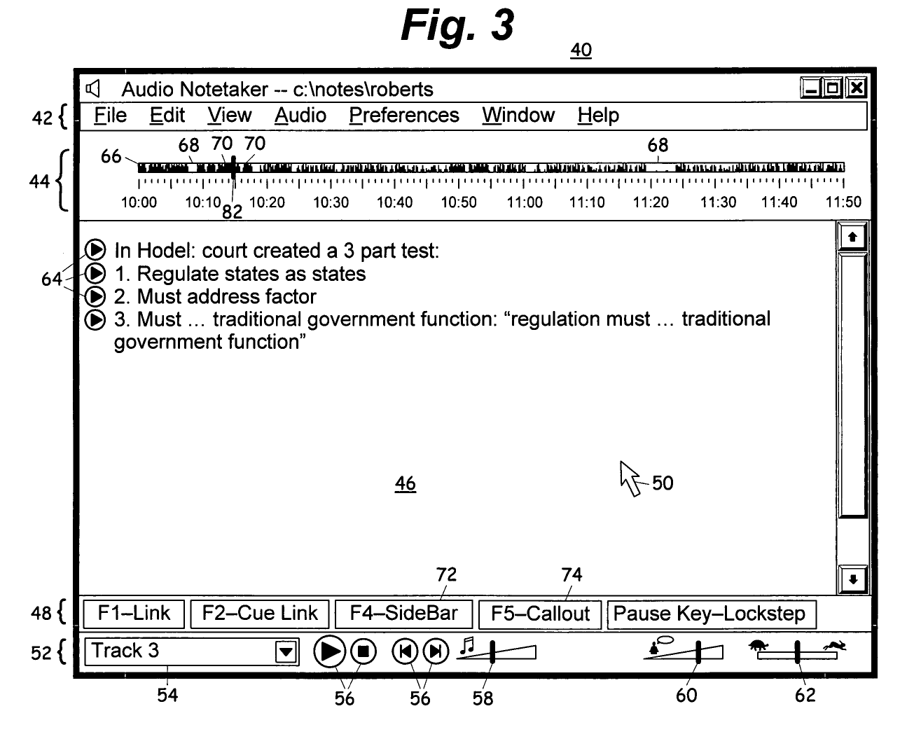

FIG. 3 shows the main screen 40 of the invention as it may appears on a notebook computer. The actual design and which items are showing at any given time is a matter of choice. It has a menu 42, a trackbar area 44, a display area 46 for notes (a.k.a. normal text or just text), a row of buttons 48 accessible by a pointing device 50, and an audio control area 52. The row of buttons 48 also serves as a reminder of what certain special keys do, such as the function keys.

The audio control area 52 controls the playback of background audio (usually music) on the left side, having a way of selecting what to play 54, typical audio control buttons 56 for the background audio and a background audio volume control 58. On the right side, there are controls for the main audio playback, including a volume control 60 and a default playback speed control 62.

The basic idea and context upon which the invention is built is a computing device that accepts notes as they are typed on a keyboard 12 or drawn or written with a pen, and automatically timestamps the notes. In the mean time, an audio (and possibly video) recording is being made of the same event that serves as source material for the notes. At least some of these timestamps are made available as links in the notes, linking particular places in the notes with particular places in the recording.

A link is a timestamp that is accessible somehow. It may be shown as a button 64, a highlight of the text like a hyperlink. Even if it not shown it may be accessible simply by selecting some notes and giving a “Play” command, or it may be a play command that searches for a timestamp near the caret (or alternatively, the cursor).

At any time (but usually after the event is over), the user may use the links in the notes to review a part of the recording, starting approximately from the point in the recording that was being recorded when the selected link was created. Because of the natural reaction time between the presentation of something the user considers important and the start of taking notes on that item, such notetaking software must provide for a “preplay” time of at least a few seconds. This preplay time means that review of the recording is initiated a few seconds prior to the time suggested by the selected link's timestamp.

(According to the preferred embodiment, the invention stores the time the link was made in the link and adjusts the time for preplay just prior to playing the audio. However, the invention also includes an infinite number of mathematically equivalent ways of linking the notes to points in the audio recording and adjusting for preplay. These include, for example without limitation, applying the preplay before creating the link, applying some before and some after storing it, storing an offset into the recording instead of a time, storing a relative time instead of an absolute time, storing a memory or disk address instead of the time, combinations of these, etc.)

The most preferred types of links are paragraph links. These are normally timestamped when the first character is typed. The text of the paragraph (including the initial character that made the timestamp) may be deleted, edited or retyped without overwriting the link. All paragraph links are displayed in a column to the left of the notes.

They look like play buttons 64. They should be shown in a disabled format (e.g., grayed) when the necessary audio is not present. They may also be shown faded when the pointing device is not near and become more intense when the pointing device approaches.

Up to every character typed can include a timestamp. These character-timestamps can be useful for hunting for timestamps that are not paragraph timestamps, such as when a teacher adds something to a previous topic and the user scrolls up to add it into the text. They can also be used for replaying (animating) how the notes were taken as the audio is playing, a feature that can be useful when providing technical support to users and coaching them on how to get the most out of the invention.

The invention may provide a track bar that shows the sound level. The history of the microphone input signal level (and therefore the audio file's sound level) is shown along the temporal length of the trackbar 66. This feature of the invention gives a visual indication of major pauses (quiet points 68) and activity (loud points 70), helping the user to navigate the recording. (When it pertains to the content of a recording, the term “pause” means a quiet point or period of relative silence in the recorded audio, such as between a speaker's sentences or words.)

The sound level history feature is implemented by dividing the temporal length of the trackbar by its slidable length in pixels, to come up with a single-pixel duration. For example, if the trackbar displays sixty minutes (3600 seconds) of recording and its slidable length is six hundred pixels, then each pixel represents six seconds of recording. This division is performed every time the temporal length of the trackbar changes (such as when the audio file changes) and also whenever the physical length of the trackbar changes (such as when the window is resized).

For example, referring to FIG. 4, at a time when a strong sound signal was recorded, the trackbar 66 shows a solid blue bar 80 perpendicular to its temporal axis. At times when the sound signal was absent, the bar is white. The bar 80 can be partly blue and partly white depending on the sound signal level during that time, proportional to a summary of the sound intensity during that time. This bar is only one-pixel wide. This bar is adjacent to similar bars, so as a group they display a kind of histogram of sound activity. Because the bars touch each other, it may not be readily apparent that it is a histogram. The trackbar also has a slider 82 that shows the current position in the audio.

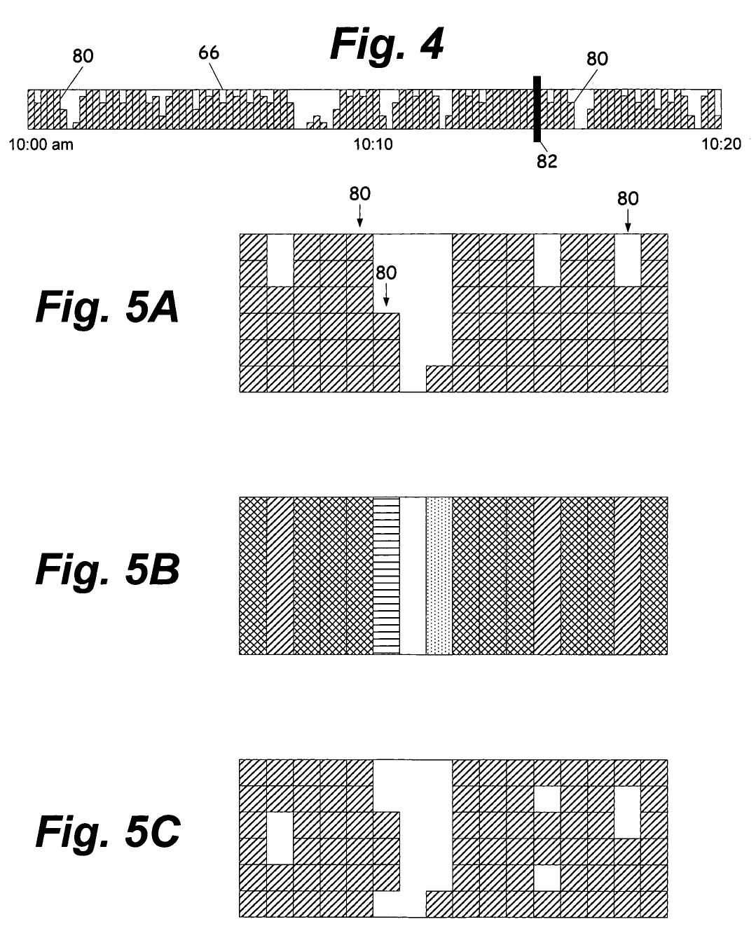

FIGS. 5A-5C show three distinct ways of showing this history. Each of the figures represent the leftmost sixteen pixels of the part of the trackbar 66 that shows the history, each also representing the same example sound. FIG. 5A shows an enlarged view of part of the histogram shown in FIG. 4 and described above.

Slightly less preferred to the histogram, but still within the scope of the invention is a way of showing the sound levels using different (solid) colors rather than different lengths of bars. Here, the shade of the solid color represents the sound intensity. The shade can vary in brightness, saturation or hue or any combination of these. This is shown in FIG. 5B, which represents shades of color with different styles of hatching or no hatching at all. Each bar can be a different shade, but there is no variation within a bar.

FIG. 5C shows another less preferred way of showing sound levels, in which the sound intensity is graphed in two dimensions. This means temporally dividing up each bar along the bar's length. For example, if the bar is six pixels high and represents six seconds of audio, then each pixel represents one second. The sound intensity represented by each pixel is shown by its shade. Then, adding this example to the example above, the entire sixty minute audio session is represented temporally in two dimensions of six by six-hundred pixels, to a one-second resolution.

To implement the preferred (or less preferred variations) of sound intensity history, the computer is directed to analyze the audio. This analysis results in a summary of the sound intensity history of the audio that is orders of magnitude smaller than the original audio. It can be in the form of an array of sound summary elements. The analysis can be done during recording or it can be an analysis of a previously-recorded file. Because audio files can be quite large and generally will not be changing, the analysis should be performed only once and then stored with the audio so that it is available as needed.

For best results, the analysis should be independent of any particular pixel resolution of the final display, since that pixel resolution is subject to change. Thus, a fine resolution such as a tenth of a second for each sound summary element is preferred, but anything from a hundredth of a second to a full second will work just fine. Even resolutions finer or coarser than those bounds will be of significant value.

The most preferred way to do the analysis is to make sure that the exceptions (pauses and intense sounds) show up somewhere. Thus, the audio should be scanned without regard to any resolution to identify pauses and loud segments. Then these pauses and loud sounds should be assigned to the nearest sound summary elements. This makes sure a pause or loud noise is not lost by being split between two elements.

When the summary is to be rendered (drawn on screen), the final pixel resolution is known and several sound summary elements will be mapped to each pixel. Generally, the average of the elements for a pixel will be used. However, where there is a definite exception (pause or loud sound) the exception should be exaggerated to make sure it is visible. If there is both a pause and a loud sound mapping to the same pixel, the one that is more exceptional to the average should be exaggerated and the other ignored. If both are equally exceptional, the pause should be exaggerated and shown. In deciding whether something is exceptional, comparing it to a predetermined number of pixels prior and after is sufficient. One to ten pixels is a good range and three is most preferred. There is little to be gained by comparing to a greater number of pixels.

As the track bar slider 82 moves, it will normally move by jumping one pixel length. This can be distracting to some users of the invention. Therefore, according to the preferred embodiment of the current invention, the slider gradually fades from one pixel to the next.

This is accomplished by updating the slider 82 position significantly more frequently than one full pixel movement. With each update, a copy of the trackbar background is prepared in an off-screen bitmap. Then the slider is “drawn” onto this off-screen bitmap, with each pixel of the slider being allocated in a prorated manner to either of two neighboring pixels. At the edges of the slider, some of the background pixel's color remains. When the prorating is finished, the off-screen bitmap is copied to it's correct place on the visible trackbar, giving slight movement to the slider without distracting jumps.

This method may also be implemented by preparing a fixed number of prorated images of the slider and showing them in succession until a full pixel of movement has been obtained, and then starting over one with the first prepared image.

The invention can adjust the default preplay parameter. As the invention is used from day to day, it should keep track of the user's commands immediately after a play from audio link command. If the user rewinds significantly more than half the time (e.g., 67% of the time), then the default preplay amount should be gradually increased. If the user more frequently fast-forwards, then the default preplay amount should be gradually reduced, but never less than a fixed limit such as three seconds.

This feature allow the invention the “break in” like a leather shoe. More specifically, it will cause the invention to adjust to a user's manner of using it, the user's unique reaction time, which is the time between hearing something important and starting to make a note of it, etc.

The invention tries to start and stop the playing of notes related audio at pauses (between words). When the user gives a play from audio link command, it is useful for the invention to perform a little fine tuning of exactly where to start playing, so that play begins at the most meaningful place possible. Specifically, if the audio link, after being adjusted for the normal preplay amount, points to a place in the audio that is just after a pause, then it should start playing at the end of the pause, rather that where it literally points.

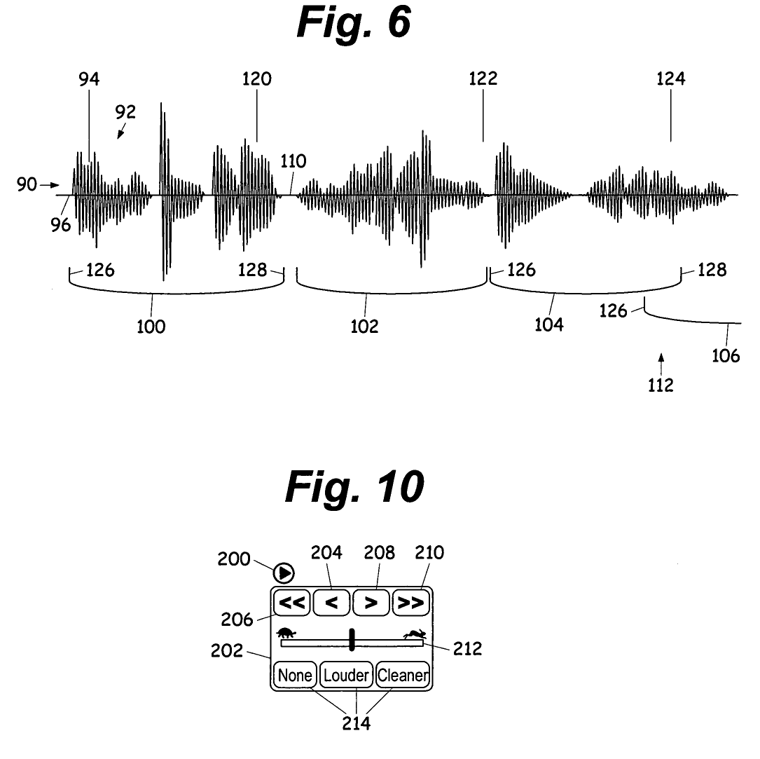

FIG. 6 illustrates this feature. A voice waveform 90 is shown schematically in the time domain. After preplay adjustment an audio link falls somewhere in a word 92, as indicated by item 94. Just prior to the word 92 is a pause 96 in the audio (a quiet part). The invention detects this and starts and further adjusts the starting point so that it starts at the end of the pause 96.

This is implemented as follows. After the user clicks on a play link, the invention looks up the link's timestamp and subtracts the appropriate preplay time according to the type of link that it is. Then it examines the audio leading up to that point. It should start by looking back at least an additional half a second, but it is preferred that it look back at least an additional preplay amount, for a total of two preplay amounts prior to the timestamp time.

Then it examines the audio between this additional preplay and the normal preplay times, looking for pauses in speech. The biggest pause wins. The audio is played starting with the end of the chosen pause. Alternatively, the last pause in the section under examination wins.

Starting in any pause is more important than starting in a particular pause. While it is preferred that the invention only look back in time from the preplay-adjusted starting point, any pause near the preplay-adjusted starting point is an acceptable way of practicing the invention. If the invention finds a pause past the preplay-adjusted starting point then this whittles into the preplay amount. If it is “near” then there is still a substantial preplay amount left to accommodate the user's reaction time between hearing something important and commencing the taking of notes.

The search for pauses can be implemented several ways. For example, it can literally search for pauses in the actual audio every time. However, the preferred way to implement this is with a record of sound levels with a few milliseconds resolution (like 100) or even just a record of pauses. This can be the same record upon which the visual display of sound levels is based. If such a summary record is not available, then actual analysis can be used as a backup.

If no summary record is available, then the recommended implementation includes, whenever the audio position is stopped, anticipating a play command and making decisions early, before the play command is given. This means preloading the audio into memory and searching for the best pause in a background thread. If the play command is not given (e.g., the audio position is changed without play), then this information is discarded.

There should be two search for pause functions. One searches for the nearest pause of a given duration. Then other searches for the longest pause within a certain time window. Each of these pause functions takes a parameter that indicates the sound intensity that is to be deemed silence.

If no qualifying pause is found, then the duration can be reduced or the search window extended slightly or the sound intensity raised or the other function tried. When handling an audio link play command, searching for the longest pause within a certain time window is the best approach, because longer pauses can indicate changes is subject.

Lockstep Playback should Start and Stop at Short Pauses when Possible. Lockstep is a feature in which small segments of audio (100,102,104,106) are played to allow for transcription before the next segment is started. Previous to the current invention, it was necessary to overlap the audio segments to make sure that a broken-up word is understandable in one segment or the next. When a lockstep play command is given, a stop command is also scheduled a few seconds into the future. This scheduled stop command is carried out when the audio position reaches the scheduled stop point.

According to the current invention, it is preferred that lockstep playback commands start 126 and stop 128 the segments at word boundaries whenever possible. This can be implemented by, during lockstep playback, searching for a pause (relatively quiet moment) near the scheduled stop point (120, 122, 124) and stopping on the best pause near the scheduled stop point (120, 122, 124).

The invention provides a way to provide lockstep playback without overlap. When a sufficiently distinct (long and quiet) pause 110 is available, then this removes the need for overlap in lockstep playback (e.g., 100 and 102). In fact, a long pause may be skipped or greatly compressed (e.g., 102 and 103). Thus, when the invention succeeded in finding a sufficiently clear pause 110 in the audio, it starts the next lockstep segment at the end of the pause in the audio, regardless of the absence of overlap or the presence of an unplayed portion of quiet.

For lockstep playback, searching for the nearest pause of a given duration is the slightly preferred function to use. The given duration should be tuned to find the slight gap that is sometimes present between spoken words. However, in any case, the pause that is found must be very close in time to the starting point, so this function does have temporal limits. If no qualifying pause is found, then the segment should stop at or somewhere near the scheduled stopping point and the next segment should provide some overlap 112 (the overlap of lockstep segments 104 and 106).

The invention provides a next-topic command. Sometimes, while taking notes, the speaker will start a new subject but the user will want to continue typing about the old subject for a time. This can reduce the accuracy with which the audio link timestamps link the notes and the recorded audio. A way to remedy this is to provide a “Next-Topic” command. The command can be given via keystroke or pointing device button, etc. When a “Next-Topic” command is given, it sets the timestamp of the paragraph to follow, even before any text is typed there, so that it becomes the timestamp of a newly-created empty paragraph. This link is a paragraph-type link. It shows up on screen immediately, giving visual feedback of the command's execution and also indicating where the notes for this next topic should go. The “Next-Topic” command does not move the caret, so the user may continue to finish the old subject. Thus, the “Next-Topic” command can be inserted into the user's typing or other data entry at any time, even in the middle of a word, to establish a timestamp without interrupting the user.

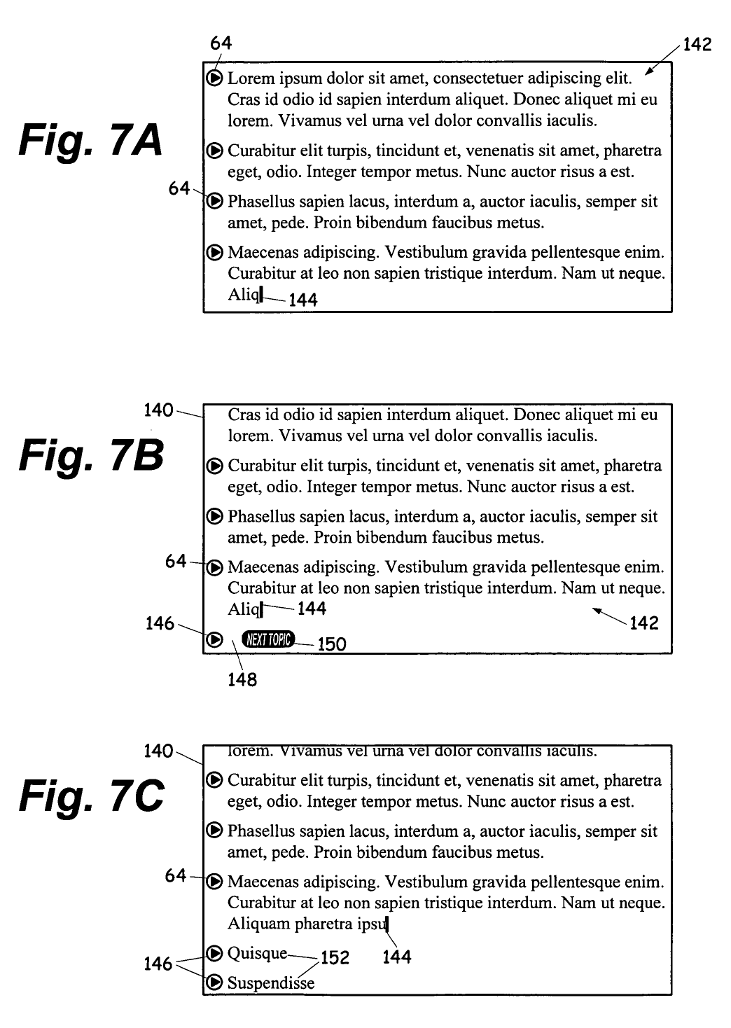

FIG. 7A-7C give examples of the Next-Topic command. The window 140 corresponds to the display area 46 for notes introduced in FIG. 3. The user's notes are represented by randomly generated dummy text known as “lorum ipsum” text. According the user's options in effect, a handle to each paragraph timestamp is visibly shown as a play button 64 at the beginning of each paragraph.

In FIG. 7A The caret 144 is shown at the end of a incomplete word, at the moment the user is tom between finishing one topic and starting another. So the user presses a function key to issue a next-topic command. FIG. 7B shows the result an instant later. A new paragraph timestamp and its play button 146 has been created at the beginning of a new empty paragraph 148, and the caret is positioned at the incomplete word ready to complete it. The notes have been moved up a line to make room on the display. The notes should be moved up only when it is beneficial to do so, meaning that some space had to be made and both the new paragraph and caret position can fit on the screen at the same time.

When the user is ready to enter notes of the next topic, which already has a timestamp, he just moves the caret to that newly-created empty paragraph 148 and begins typing. In this case, the first letter typed in this paragraph does not overwrite the timestamp. The original timestamp survives.

Normally, when the user types the Enter (or Return) key somewhere inside a paragraph, the paragraph is split at that point. If the caret is at the end of a paragraph, then normally the caret moves down to the beginning of a newly-created paragraph. However, optionally, for the purpose of making “next-topic” paragraphs easier to get to, when the Enter key is pressed at the end of a paragraph and the next paragraph is empty but has a timestamp, then the caret moves to this newly-created paragraph 148 instead of creating a third paragraph.

Multiple “Next-Topic” commands set the timestamps of multiple newly-created paragraphs. They appear in chronological order. This means that it is possible, for example, to create a new paragraph and timestamp that is several paragraphs below the cursor, all without moving the cursor. It is up to the user to remember which empty paragraphs are which, if the user desires to do it by memory. In any case, the audio links are there and they can later be used as a reminder.

Optionally, the invention can display next-topic reminder 150 as the visible link, or near to an ordinary-looking visible link 146. This will be at or near the beginning of the new paragraph 148. The next-topic reminder 150 may be a symbol, callout or specially highlighted text. The next-topic reminder is automatically removed when the user moves the caret to the beginning of the new paragraph or (more preferably) starts typing text there. The purpose of the next-topic reminder is to help the user understand what the Next Topic command does, by, for example, displaying the text “NEXT TOPIC . . . . ”

To help distinguish multiple next-topic reminders that are active at the same time, multiple next-topic reminders may each display unique identifying information. This could be a number, the link's time of creation, the link's age, or any combination of these. If it is the links age this should be shown by lightly (with low contrast) counting the seconds since its creation.

FIG. 7C shows another way to identify the next-topic reminders, which is to obtain some unique identifying information as part of the command. For example, initiating the next-topic command causes the invention to prompt the user with “Type Next Topic and press Enter:” Anything typed before the Enter key becomes a next-topic label 152. The next-topic label 152 is displayed as the first text of the new paragraph. Subject to user options, it can be automatically bolded or have punctuation appended to it or otherwise treated differently. After the Enter key is pressed, the caret returns to its location at the time the next-topic command was given.

The Enter key should not be the only key that can end the “Next Topic” prompt. Clicking the pointing device in the notes area or pressing the same function key again should also be able to end it. This makes it possible to create a next-topic paragraph by rapidly pressing that function key twice. Of course, then the next-topic label would be blank.

Automatically generated next-topic reminders should disappear as soon as the user moves the caret to the new paragraph. However, (prompted) next-topic labels should be retained and treated as the beginning of the next topic's notes.

The prompt for a next-topic reminder should initially be a small Next-Topic Window that pops up. This small window accepts a next-topic label and explains what is happening and what the user is to do. It also provides options, such as a checkbox that this window should not be shown again.

If the user options indicate that the Next-Topic Window should not be shown, the next-topic command causes the caret to be temporarily moved to the newly created paragraph. The automatic next-topic reminder appears (if enabled) and optionally a tiny non-modal callout or popup hint show the prompt. Another tiny callout or popup hint or symbol visibly marks the caret's original location and preferably indicates which key(s) will return the caret to that point. When the user ends the next-topic label by typing one of those keys, the prompt and original caret location marker disappear, and the caret returns to the original location. The automatic next-topic reminder remains until the user moves the caret to it. The next-topic label stays unless the user expressly deletes it.

It is preferred that the invention provide both automatic and prompted next-topic reminders by default. It is also preferred that the user be able to set preferences to individually disable automatic and prompted reminders and to choose the types of automatic reminders to use.

The current invention can have modes of operation for primarily keyboard input or primarily pen input. Keyboard input should be the primary mode for keyboard devices such as notebook and desktop computers. Pen input should be primary for tablet and handheld devices that have no convenient keyboard, but are designed to electronically detect the presence and motion of a stylus. An implementation may provide for switching between modes, applying different modes to different parts of a document, or being limited to one mode or the other.

It can apply the different modes to different parts of the document at the same time, giving the user the experience of a “non-modal” user interface. This is done by sending keyboard input to an relatively ordinary word processor interface for addition to the keyboarded text and movement of the keyboarded text's caret. (The caret is the line that is usually blinking and shows where typed text will go.)

Simultaneously, on the other hand, pen input is treated in one of three ways:
1. If the pen input is being used to write characters as an alternative to using a keyboard, then the drawn characters will be recognized character by character and treated like keyboard input just like the keyboarded text. Some ways to recognize this method include writing characters not just anywhere but in a special box designed to receive characters one by one.
2. If the pen input is being used to write character anywhere on the document and not in a special box, then the characters may be recognized and placed near where they were written in a freeform manner.
3. If the pen input is not being used to write characters (or they just aren't being recognized), then the drawn lines are stored on the document where they were drawn. This facilitates the drawing of sketches.

In any of these, the timestamps are still made and at least some links are made available to the user.

Sketches and other graphical elements (e.g., images) are treated as objects that the word processor wraps around. The word processor may also be used to give captions to these objects as a property of the object. This enables the same document to have a mixture of graphical elements (including sketches) and keyboarded (or recognized) text.

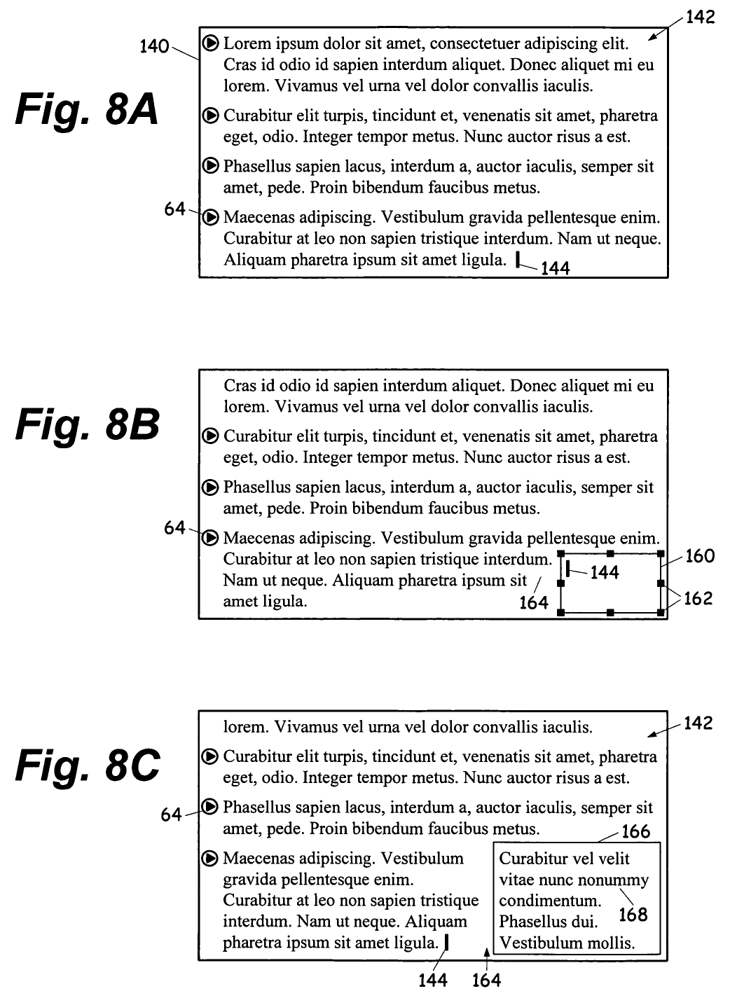

FIGS. 8A-8C show a type-anywhere feature of the invention. For notebook and desktop computers that don't have convenient pen input, it may nevertheless be desirable to be able to write something outside of the normal flow of the text. The invention provides for sidebar boxes that contain notes or images or sketches made with the pointing device. The preferred method of creating sidebar boxes include the following:
1. Providing a sidebar box button 72 (FIG. 3) that creates an empty box on screen. If the pointing device is clicked on this button and then released somewhere in the document, the box is created near the release point. Otherwise, the invention just guesses where the box should be created.
2. Right-clicking and selecting “Insert sidebar box.” The box is created near the point of the right-click.

FIG. 8A shows a window 140 that corresponds to the display area 46 for notes introduced in FIG. 3. It is shown just prior to issuing a create sidebar box command that lets the invention guess where to put the box. It guesses near the caret.

As shown in FIG. 8B, immediately after the new sidebar box 160 is created it has the caret 144 inside and is already selected so it can be moved and resized at will. When it is selected, eight handles 162 are visible. Using the arrow keys, while the box is selected and empty of text causes the box 160 to be moved around in increments. Arrow keys combined with the shift key cause the box to be resized by moving the lower-right corner in increments until a margin is hit, and then it continues to increase in size but its position is adjusted so it does not cross the margin. When the user types ink-printing characters they show up at the caret and the selected state of the box goes away so that the arrow keys are available for moving the caret in the text. The box may be reselected by clicking on it with a pointing device. As shown near reference number 164, the text (notes) of the document are reflowed (word wrapped) around the box as necessary when it is created and whenever it changes size or position.

FIG. 8C show the sidebar box 166 after some text 168 has been entered into it.

If text is selected when a sidebar box is created, the selected text is moved from the document to the inside of the box and the box is positioned near the point where the selected text used to be.

When the invention has to guess where the a sidebar box should first appear, it should favor making it flush with the right margin of the screen and just barely above the caret. The initial size should be small, and it can grow to allow for more text as it is entered. The text inside a sidebar box ordinarily has timestamps and links as usual.

Preferably, sidebar boxes are anchored to a paragraph in the document so that they scroll in and out of view with the text that wraps around them. Preferably, a large sidebar box could have more than one paragraph wrapped to the side of it so that no space is wasted. The anchoring paragraph could start above, at or below the top of the sidebar box, as determined by user options. The preferred default is that the vertical centers of the paragraph and sidebar box are aligned unless another sidebar box causes some crowding.

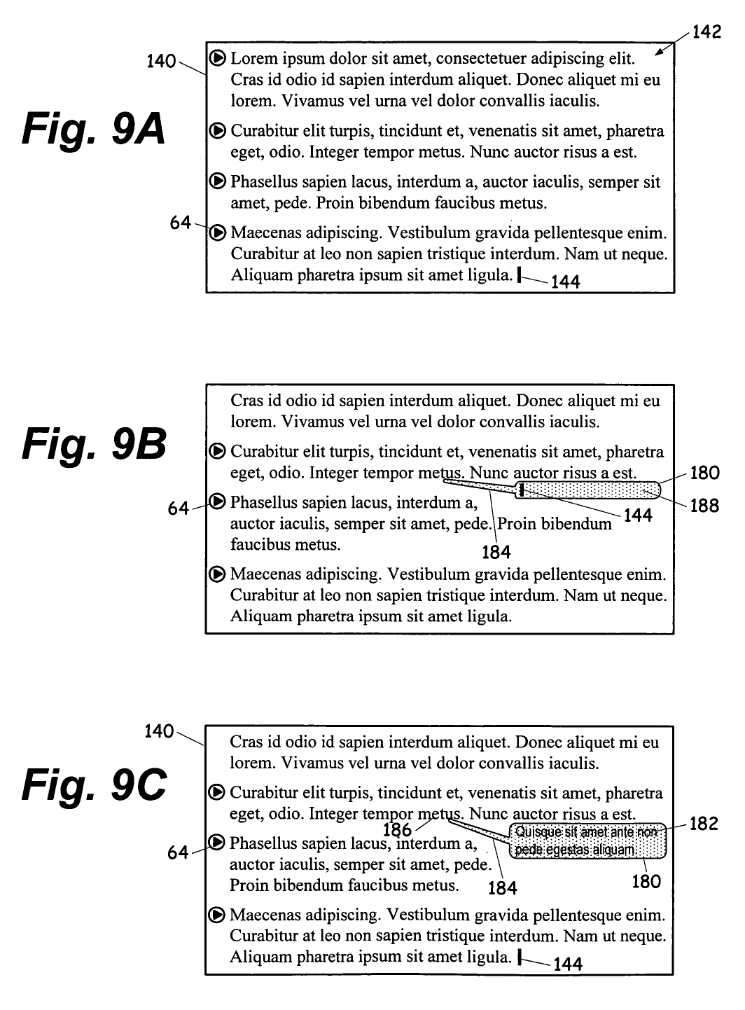

FIGS. 9A-9C show how the invention allows the user to conveniently create callouts. FIG. 9A shows a window 140 that corresponds to the display area 46 for notes introduced in FIG. 3, just prior to a create callout command.

A callout 180 (FIG. 9C) is explanatory text 182 associated with a particular part of the user's notes. The invention shows callouts as connecting indicia 184 pointing to some kind of target 186 (e.g., a word in the text) with the explanatory text 182 on the other end of the line. The connecting indicia is usually a line, but if the target is a large block of words then it may be a bracket or brace to indicate the scope of the target. Preferably, the target and explanatory text are distinguished from each other by one or more indications including putting an arrowhead on the target end of the line or the direction of the bracket or brace, putting the explanatory text in a box, shading the background of the explanatory text, or displaying the explanatory text in a different font (usually smaller).

To create a callout, the user chooses the target 186 and issues a create callout command. This can be done in either order. The target can be chosen by placing the caret in the target word or by selecting one or more words. The create callout command can be issued by function key or callout button 74 (FIG. 3) accessible by a pointing device or right-clicking and selecting “create callout.” As shown in FIG. 9B, the invention then draws the connecting indicia 184, prepares a small but expandable area 188 for the explanatory text and places the caret 144 inside the expandable area.

Callouts and sidebar boxes never exceed the bounds of the main window 140, so as to create a need for a horizontal scroll bar. Instead, if there is not enough space for them, they are enlarged to the interior of the main window 140 and the normal text 142 is reflowed around them.

Callouts should be inserted in the nearest space that can be found or made near their targets, even between lines when sufficient space is available. The standards are on-screen readability and clarity, not beauty, so some crowding is acceptable. The callout target flows with the normal text, and the callout text itself can be moved to wherever there is a nearby space as necessary, so callouts will be relatively mobile.

As for audio filtering, generally, no unnecessary filtering of the audio is done at record time. The purpose of recording is to capture the audio data. The audio may be compressed, preferably with a lossless method of compression.

The audio may be digitally filtered upon playback to increase its volume and filter out unwanted noises. The human ear is remarkably good at picking a voice out of extraneous sounds. However, extra sounds can be annoying and distracting and reduce the perceived quality of the invention.

Preferably, the user is given a choice of filters, one of which is the default filter. Normally, the default filter will be active and the user will not need to make any changes. The other filters are there only for when the audio is particularly troublesome. The filter choices may preferably include:
1. No Filter. The recorded audio plays as is.
2. Amplification Filter. The recorded audio is played with a certain level of amplification. The user can adjust this level. The “No filter” option may be provided as a special case of this amplification filter in which there is no amplification.
3. Compression and Expansion filters. These may be used to manipulate the dynamic range of the audio.
4. Normalizing Filter. All the audio is brought up to the same volume level. This is excellent for making weak sounds understandable but it is tiring to listen to for a long time because background noises and hiss are brought up to full volume.
5. Speech Band Filter. This filter retains the frequencies used in speech and attenuates the frequencies above and below speech. The frequencies used in speech are about 250 to 6000 Hz. A higher level of filtering may be achieved by noting that speech is usually located in two bands between 250-500 Hz and again at 1000-4000 Hz. The other frequencies can be filtered out.
6. Specific-Speaker Pick Filter. This is like the speech band filter but the actual pitches used by a speaker are determined first and then used to provide a more specific filter.

Filters can be combined, but not necessarily in any order. A useful combination is a normalizing filter followed by a speech band filter.

To implement the Specific-Speaker Pick Filter, the actual pitches of what is likely speech are detected and their waveforms including integral harmonics are extracted using a subtractive process that reduces the energy content of the signal. If the first attempt at subtraction didn't pick out the signal well enough, it may be repeated iteratively until the energy level of the remaining signal is minimized. Energy level is the sum of the squares for the period of time of interest.

Speech may at times have more than one fundamental frequency at the same time. The fundamental speech frequencies and their harmonics are functions of time because pitch can change for some speech sounds. The amplitudes of these fundamental frequencies and their harmonics also change with time. In order for subtraction to remove the speech signal from the recorded signal, the best way of representing these speech waveforms is in the time domain, with each fundamental frequency detected receiving its own time domain waveform and set of time domain waveforms for all the harmonics of interest. Each set of waveforms is long enough to match the waveform in the recorded audio.

This set of waveforms is referred to as a waveform object. The waveform object has a number of arrays of whatever length is needed. Each array stores a idealized sine wave. The sine waves are idealized in that they don't themselves contain any harmonics. However, they are expected to vary in intensity from one cycle or peak or valley to the next. Additionally, they can vary in pitch. This means that after a starting time is established (the sine wave being assumed to start at the value of zero at that time), each cycle of an idealized sine wave can be represented as four numbers:
1. The value of the peak (or valley)
2. The time (moment) when it crosses zero.
3. The value of the valley (or peak)
4. The time (moment) when it crosses zero.

These four numbers are repeated over and over until the waveform is lost in the signal. The value of the signal at any point between peaks and zero's can be obtained from the sine function (best by lookup table). The zero-crossing moments do not need to correspond to a moments that data sample were taken, meaning that the idealized sine waves can cross zero at any time between samples. (Alternatively, the value and time of the peaks and valleys could also be used to define the idealized sine waves. They could even be defined with some loss of precision with only two numbers per cycle: an amplitude and a duration.)

Fundamental frequencies are detected using any of the methods ordinary used to detect the presence of a pitch in a sound signal. Once a pitch is detected at a certain point in the audio, a waveform object is created and an idealized sine wave is stored in a new set of waveforms, starting with the fundamental frequency. The signal is analyzed to arrive at the best guess of the intensity of the fundamental frequency at each point. This idealized fundamental frequency is subtracted out of the signal in a tentative manner so that the resulting residual energy of the signal without it can be measured.

It should be kept in mind that the fundamental frequency of a signal is not always stronger than the harmonics. Thus, if the fundamental is high enough that a half or third or even quarter of the frequency could still be in the range of normal speech, then these fractional frequencies must be tested to see if they are present in the signal. If any is found, then the lowest becomes the new fundamental and the other(s) take their place as harmonics.

Having found the true fundamental frequency, the invention next checks for the presence of each integral multiple of the fundamental frequency. In other words, it checks for harmonics. It is important to note that in checking for harmonics, the actual duration of individual cycles of the fundamental (and lower harmonics) must be used because the harmonics will stay in sync with them. In sync does not mean in phase; the harmonics may have any phase relationship with the fundamental. However, if the actual duration of lower-frequency cycles is not used to look for a harmonic then whatever is used in it place (such as a steady pitch harmonic) will likely drift in an out of phase with the actual cycles and give an incorrect result.

When a harmonic is found, the duration of its cycles is stored in the appropriate array of the waveform object and the best extraction of its intensity at each cycle is also stored there. If there is uncertainty as to what the intensities are, several guesses can be tried using the tentative subtraction and energy measurement techniques. Then standard numerical methods techniques can be used to gravitate towards the best guess, which is then treated as the actual extracted harmonic and a non-tentative subtraction removes it from the signal.

After all the harmonics are removed, the remaining residual signal may be examined for another pitch, which could be from an unrelated source. If another pitch is found, the process is repeated for the other pitch.

At any time, if any intensity of the fundamental or harmonic frequencies appear to remain in the signal, the idealized sine waves may be adjusted to lower the residual energy of the signal. Changes in the idealized sine waves are reflected by subtracting them from or adding them to the residual signal.

The residual signal will contain certain speech sounds (phonemes) that are not based on a particular frequency or pitch, such as the t, f and s sounds. These sounds are separately identified by strong but short-lived activity in a frequency band. Generally, they are characterized by their ability to mask other sounds, and so they can be moved to a special pitchless waveform object that just is a record of them in the time domain, with no harmonics.

The various waveform objects, including the pitchless ones, should be examined to determine if any are clearly not related to speech. This step is done by rule (likely frequencies where the fundamental should fall) and also by statistics. By changing the rule, it might sometimes be possible to separate out deep voice and high voice speakers from the same recording, even though there were talking at the same time.

With all the filtering done, the filter output is generated by discarding the residual audio and reassembling the waveform objects in the time domain. If desired, this is an excellent time to do time-stretching or compression by adding or removing redundant cycles as desired.

The invention provides a choice of filters to make the voices most understandable. User can right click on a link (or otherwise indicate choice) to change filters and to change the parameters of the filters.

The invention includes an always-on recording feature. This optional feature of the invention is to provide a computing device with a separately-powered audio record section, so that even when the device is off or in a standby mode, it can still be recording. When the device is turned on or awakened and a note is made, this note is linked to the recording as usual. This provides the added benefit of being able to preplay the audio from a time while the device was off or on standby. It makes it possible to record and easily retrieve the sounds that prompted the user to turn the device on or wake it up. It means that the user does not have to ask anyone to repeat themselves. It also means that the user will be able to record and easily access sounds that can not be repeated.

Different implementations of the invention may differ in how much recording they keep while the device is off. Some may save all audio to permanent storage. Others may retain only the last few seconds to minutes unless a note is made. There may be any range in between, including voice or sound activated recording.

Some devices may contain large amounts of non-volatile RAM. Other devices may contain both volatile memory and permanent storage. Certain types of permanent storage such as flash memory and disc drives require less power if audio is first stored and is saved up in low-power volatile memory and then written to permanent storage in batches, which is powered long enough for the writing to take place. Continuous audio can be recorded with little power consumption by writing batches regularly. The amount of volatile memory that is available and the bit rate of the compressed audio will determine how often these batches have to be written. It is feasible that batches need to be written for only a few seconds every few hours.

An external timestamp button (16 and 22 in FIG. 1) may be placed on the outside of an embodiment of the invention. This is an optional feature. Its purpose is to make a timestamp at any time, even while the device is off or asleep in a standby mode. This is provided for use when, for example, someone hears something they want a record of and their PDA, which includes the current invention, is in their pocket. The user just casually pushes a button on the outside of the PDA, perhaps from the outside of his or her pocket, and is done.

If the device is recording to volatile memory while off or asleep, pressing this button is also a signal to write all available audio to permanent storage, and to continue to acquire and write new audio for a predetermined time or until a predetermined event. The predetermined time may be in the range of ten seconds to several hours or anything in between, but a range of about one to fifteen minutes would be most useful range, with five minutes being the factory-set default time. The predetermined events could be switching on or waking up the entire device (at which normal recording mode takes over), or switching this mode off via a specially-provided button, or the detection of a predetermined length of silence. The silence need not be absolute silence, but rather lack of detectable speech.

Background Music is another feature of the invention. This provides integrated music when not playing notes-related audio. This allows the user to listen to prerecorded music while improving and studying notes. If the user clicks on an audio link, the music is interrupted and the notes-related audio plays. The music can be interrupted by being paused, completely muted or partially muted. Preferably, all of these choices are made available to the user. The difference between pause and mute is whether or not the position of the playing is frozen or continues to advance, respectively. (Here the term “pause” is being used in the command sense, such as whether or not to play recorded audio; it is not referring to the content of the recorded audio such as a recorded moment of silence.)

When the user stops the notes-related audio, the music resumes, preferably after a user-configurable delay. The purpose of the delay is to prevent little bits of music from being inserted between play commands in an annoying manner. Thus, when the music resumes, it is likely going to play long enough to be enjoyed.

The background audio can fade in and fade out. When the music is stopped it preferably fades out over a fraction of a second, such as a quarter of a second. When it resumes it should preferably fade in over a period of time that matches the fade out time all the way up to about two seconds. Fade-in and fade-out require a greater level of control over the other audio stream.

If the notes-related audio is paused rather than stopped, the behavior of the invention may range from resuming the music the moment the notes-related audio is stopped, to resuming it after a preconfigured delay, to not resuming the music automatically. This behavior can be a user configurable option. The preferred default behavior is that it waits significantly longer to resume the music and fades in significantly slower.

Background music can be implemented several ways. An embodiment of the invention may provide for multiple ways of doing it, and choose a way based on where the background music is coming from.
1. If the music is coming from an independent application such as REALPLAYER or MICROSOFT MEDIA PLAYER, sending commands (pause, mute, play) to the other application.
2. If the underlying hardware and operating system allow the music stream to be interrupted, interrupting it via operating system messages. For example, if an embodiment of the invention can obtain a handle for the music stream and has or is able to get the requisite permissions, using the handle to send command messages to stop and start the music. (A handle is a way of making reference to a specific object that is managed by an operating system. Usually it is a number assigned by the operating system that is meaningful in the particular context in which it was assigned.)
3. If an audio mixer is present, sending the notes-related audio to the mixer. If possible and necessary, sending settings commands to the mixer as well. Such commands would set the volume control input levels for each source of audio.
4. Providing music play capability within the invention so that there is no need to deal with other software. This option is the most preferred because it gives the invention total control over the music stream and mixing.

True Continuous Background Music is also a feature of the invention. The “mute” button on the remote controls for many consumer electronics devices means “complete silence.” However, according to the current invention, the background music may be partially muted. This means it continues at a reduced volume level and is mixed with the notes-related audio, which is louder. Preferably, the relative volume level is set according to an examination of each audio source. This relative volume level can be a user preference with a range of about zero to forty decibels. The default should be about twenty decibels. This option will be most useful when the notes-related audio is of very good quality.

The invention is not limited to music for its background audio. It does not even know nature of what the user has chosen to play in the background. While most users will probably choose to listen to music in the background, others may choose to listen to white noise, sounds of nature, or even a speech. Thus, to the invention, it is just background audio.

Timestamping Without Recording. Preferably, the invention should timestamp new text even when it is not recording. This is because the recording can be done by another device the invention doesn't know about. Then the recording can be imported or otherwise connected later. When links exist but the invention does not have access to any audio, the links should be shown disabled (faded or grayed) as previously taught.

When note-related audio is imported, it is usually important to determine the actual time and date the recording was made. If the file modification time has not been corrupted, it usually refers to the ending time of the recording. The possible starting time of the recording can be computed and presented to the user for acceptance or modification. The user should be given the options of accepting the time as is, adjusting it slightly to accommodate differences in clocks, and changing it to any arbitrary time. To help the user in this decision, the invention should report how many links or timestamps would be enabled because there is now audio behind them.

Institutional Recording. One situation in which separate recording is advantageous is in an institution such as a school or business. A special institutional version of the invention can be prepared. This institutional version includes recording devices and software, a server and software, client software, and a network. Often the network and maybe some other parts such as a server may already be present in the institution.

The recording devices include microphones strategically placed in one or more rooms. These microphones record either on a voice-activated or an as needed basis, so that they record various classes, lectures and meetings. The audio recordings are placed on the server.

The clients include the software to take timestamped notes and play from links. The institution may preconfigure various computing devices with the software or just provide the software for use on existing computing devices belonging to the various client users.

When the client user (i.e., user of a client machine) takes notes, the timestamps are automatically entered and links are shown. The links will be disabled if the client doesn't know which room it is in. If the client knows which room the notes were taken in, then the links will usually show up as enabled, subject to a few conditions explained below.

The client may be informed of the correct room in any of several ways:
1. By a schedule. For example, the user previously indicated that a class will be held in room 303 from 8:00 am to 8:50 am every Monday, Wednesday and Friday. Because of this schedule, any notes taken during those times are linked to the audio recorded from room 303 onto the server at that time.
2. By explicitly picking a room from a pick list preconfigured by the institution.
3. Electronically, by the room or microphone wirelessly announcing its identity and the client computer picking up on this.

When a link is clicked, the client fetches the desired portion of the audio from the server. This can be accomplished over a wired or wireless connection. The audio is streamed to the client, meaning that the audio starts playing before all the audio has been downloaded. The clients can be configured by the institution to either save or not save the audio that was downloaded, or just to buffer it for a limited time such as one session.

Additionally, the clients may be configured to detect when they have a high speed connection to the server (such as a wired connection) and in response to having a high speed connection, to download all the audio they are missing, without waiting for the client user to click on a link. This does not mean that they try to download it at the maximum possible speed. The institution can configure it so the download is throttled at some speed or so that it relies on otherwise unused bandwidth.

Institutional Control Over The Recording. One of the advantages of the current invention's institutional version is that it can be used to overcome reluctance some speakers may have to allowing recording of their words. The word “speakers” is used generically to mean teachers, professors, lecturers, students, managers, employees, etc. This is accomplished by giving them control over the recording, so that they can decide after the event is over whether they want everyone to have access to it. If they said something wrong or simply embarrassing, then they can fix it or disable access.

Another advantage is that it allows the institution to better avoid copyright problems such as might be created if copyrighted material is played and the audio track is recorded by several copies of the invention. The institutional version of the invention provides a way to switch off recording from the microphone so that copyrighted material is not inadvertently copied. Sophisticated versions of the invention can be configured to automatically turn off the microphone under certain conditions such as a projection screen being lowered or a built-in TV being turned on.

To implement institutional control, the invention provides a way to accept and manage a schedule for each room with a microphone. One of the fields in this schedule is a speaker (such as a professor) who is in charge. This speaker may configure all his events to be:
1. Available for download immediately.
2. Available for download after the speaker indicates so, after each event. This permission will be sought automatically by the speaker's workstation and can be given as easily as pressing a button. It may be as flexible as enabling and disabling blocks of time.
3. Not available for download except to listed individuals. These individuals may be configured on the speaker's workstation at any time, such as if a student has a good excuse for missing a class.
4. Never available for download.
5. Never recorded in the first place.

The invention can include clients that can not record. To further enforce institutional control over the recordings, institutional client software provides for the institution to disable the recording feature either entirely or during the institution operating hours or whenever the client computing device detects a room or microphone that is announcing its presence. Additionally, the institution has the power to delete audio from client machines when this audio has been previously downloaded from the institution's server. The deletion takes place as soon as the message is communicated to the client.

The invention can provide usage statistics in institutional recording. Another advantage of the institutional version of the invention is that the institution can collect statistics on what parts of a recording are accessed most often. This can indicate important or confusing parts of a presentation. The statistics can be gathered in two levels:

The institution's server will collect stats on the audio link play commands it processed. This is the basic level and will be fairly complete if automatic downloading of audio is not enabled.

If automatic downloading of audio is enabled, then the clients will report to the server the audio that was actually played.

The server can also be configured to request a copy of each client's links to the audio. These data are then combined into a histogram chart showing where the most activity was during an audio presentation. The statistics on link generation and use can be reported to the speakers to help them improve their presentations.

If the server is configured to automatically download audio to clients, then the sections of audio that have the highest history of review are put first in the queue for automatic download to clients.

Each link to the audio has certain properties. These properties should be accessible to the user, such as by right-clicking on a link and selecting “Properties.” When the properties dialog displays, it shows that individual link's timestamp, audio file, preplay properties, what kind of link it is (paragraph, character, etc), etc. The preplay property defaults to the standard preplay for links of that type, as modified by the user's usage history or explicit modifications. The properties dialog gives the user a chance to modify the individual preplay property of the link.

Default preplay and default time compression can be overridden on a per-file basis.

Links can have a popup menu. Each paragraph level link has a way to get to a menu of actions and items that pertains to that link. For example, on a notebook or desktop computer, right-clicking the link would open up a popup menu. The menu choices include actions such as play (at normal speed), play accelerated, play with different filters, play with 5, 10 or 15 seconds of additional preplay, etc.

Another optional feature of the invention is to expand the icon or handle for a link when the pointing device approaches it, so as to provide choices such as play, play fast (accelerated), and to provide various levels of preplay.

FIG. 7 shows still another way to provide these options, which is to wait until the link 200 is clicked and audio starts playing, then provide a popup menu 202. This popup 202 has a review button 204 that lets the user scan or play the audio backwards somewhat faster than normal speed, for example two to four times faster. This can be used to search backwards, effectively increasing the preplay time. A review faster button 206 can scan the audio backwards even faster, for example, five to ten times faster 206. When the going backwards, it is preferred that the invention play short bits of the audio forward, with each successive bit coming from an earlier part of the recording.

A fast forward button 210 plays the audio while moving forward quickly, for example five to ten times faster. This is sometimes called “cueing.” It is also preferred that it play short bits of the audio at normal speed and skipping forward between bits. A play button 208 lets the user return to normal play after finding the desired place in the recording.

The popup 202 also has a pitch-corrected playback speed control 212 that is initially preset to match the default playback speed control 62 on the main window 40 (FIG. 3). The popup's pitch-corrected playback speed control 212 is useful for temporarily overriding the default speed for the current audio link 200 play command only. The popup 202 also provides various filter buttons 214 so the user can select different audio filters.

Still another optional feature, for users with a scrolling wheel (like a scrolling wheel mouse or mouseless equivalent), is to let the scrolling wheel control playback position during playback. For example, pulling the top of the scrolling wheel towards the user (which normally scrolls down a document) will advance the playback position. It should really play fast to the new position rather than just jump to it. The opposite direction does the opposite. This feature can be explained by a popup after a link is clicked.

Still another optional feature of the invention is to provide a visual display of audio level as a function of time near the link. This display can be initiated when a link is selected by being hovered over or clicked, or by a right-click submenu option. Once displayed, it will visually show pauses over a period of time of about ten seconds to a minute leading up to the timestamp time. Then if the user clicks on a point in the visual display, audio will start playing at that point.

Still another optional feature for users with a scrolling wheel is to let the scrolling wheel control the speed of the playback. For example pulling the top of the scrolling wheel towards the user increases the playback speed and pushing the top of the scrolling wheel away will decrease the playback speed. This feature can be provided instead of or in addition to the use of the scrolling wheel for controlling playback position. For example, if the scrolling wheel is depressed (or control key is depressed, etc.) then the movements of the scrolling wheel control playback speed. Otherwise, it controls playback position. An advantage of providing both of these features is that if the user missed something due to the speed being set too high, and wants to hear it again slower, all it takes is scrolling the wheel away with the wheel depressed part of the time.

The feature of replaying slower is so useful that a variation of it should preferably also be an easily accessible command by function key and pointing device button. The amount to rewind and replay is preset as a user preference. The default amount should be in the range of one to thirty seconds of real time (not timestretched), with about four seconds being the preferred default. This amount to rewind is cumulative if the command is issued more than once in rapid succession (before returning to the original play point). The playback speed during replay (the replay speed) is based on a user preference. The replay speed can either be normal speed or a slowdown of the playback speed in effect just prior to when the replay slower command was given. The default should just normal speed, as this removes all timestretching distortion. Preferably, the user should be able to set the replay speed to a relative speed in the range of zero to one hundred percent longer. The slowdown is relative to the playback speed in effect just before the replay slower command is given. For some settings the resulting speed may be slower than normal speed. Preferably, the amount to slow down is not cumulative even when the command is issued repeatedly, but is applied only once. After the playback returns to the original play point (the point where the command was issued), the playback speed is restored to the pre-command setting. Preferably, this restoration of the playback speed is accomplished gradually over about a second of time. This replay slower feature has the effect of making it safer to listen to audio at the maximum speed one can understand, because it is so convenient to go back and replay any occasional part that crosses the line into unintelligibility.

The current invention includes a unique use of speech recognition technology, which is to use automatically-recognized speech in a separate window to quickly find a desired point in the audio to replay.

Currently, speech recognition technology is not sufficiently advanced to reliably recognize words spoken from across a noisy room. However, the current invention can make use of speech recognition that is imperfect. Even if only 50% of the words are recognized correctly, they still give users viewing these words an idea of what was being spoken. Then the users can click in the automatically recognized words to indicate the point in the audio that they want to hear again.

Thus, optionally, the current invention attempts speech recognition. It displays the automatically recognized text in a separate area. This area is also scrollable. Any click in that area is interpreted as a play command starting from just a second or so prior to the clicked word's audio, so as to play the recording corresponding to the automatically recognized word that was clicked.

This scrollable area of automatically recognized text can appear in response to a right-click on the link followed by selection of this option. It can also be configured to appear as a popup in response to hovering over a link.

In spite of the fact that the speech recognition does not require high accuracy, accuracy can nevertheless be increased by the invention examining the typed notes and looking for words that might be the correct translates of the audio. Whenever the invention has more than one potential translate for a word, it and one of these potential translates is found in the user's notes, the word found in the user's notes should be favored. This is especially helpful for less common words such as jargon.

Optionally, whenever the speech recognition portion of the invention has a difficult time selecting from among two or more possible words as translates for a spoken word, it can present the alternate choices to the user. This is done by selecting one of the possible words (even if arbitrarily) and indicating visually that there are alternates, such as by marking it with a symbol and or color. Then, when the cursor is hovered over the word so marked, a list of one or more alternates appears nearby. The user can choose to click on one of the alternates to make a replacement. These choices may be presented even if the invention selected a possible translate that matched a word in the user's notes, just in case the match was in error or not exact.

The filtering analysis in which specific speech sounds were picked out of noisy audio signals, disclosed above, can also be used to provide input to a custom speech recognition engine, should one be prepared. However, most of the current invention is expected to work with off-the-shelf speech recognition technology that provides sufficient connections or hooks into its inputs, outputs, and internal operations.

The invention also includes an optional enhancement that allows preplay to cover more audio in less time. When enabled by the user, the invention starts play even further back in the recording than the preplay time would otherwise direct. It also increases the initial playback speed to the maximum that could possibly be useful. (The preferred default maximum is about 100% faster, which is also adjustable by the user.) Then, as the invention zips through the audio and gets to the normal preplay point, it transitions down to the user's regular choice of play speed and continues normally from there. This feature helps accommodate the uncertainty that is inherent in the preplay settings and in the timestamps themselves. The extra amount of time to go back and play at maximum speed is called the zip time. The zip time is adjustable by the user. Preferrably, it should be given in real time (not stretched or compressed), and defaults to be equal to the preplay time, effectively doubling the preplay time. Its settable range may be from zero to sixty seconds or from zero to ten extra preplay times. Preferably, the transition from zip audio to regular audio does not sound too abrupt. In other words, it should not make a clicking sound. It may be very gradual or instantaneous. When combined with the start at pauses feature, the invention applies the zip time first and then searches for a pause in the recorded audio.

The above features enhance a computerized notetaking system by increasing its usability and appeal to the user. They increase the likelihood that a user will capture important audio. They increase the likelihood that the user will be wearing earphones or otherwise have audio output enabled when reviewing notes. They improve the sound quality of notes-related audio, as well as improving the exact starting and stopping points of notes-related audio that the invention is directed to play. They provide an alternative way for users to choose which portion of the audio to play. There are many other enhancements not repeated here. Any of these enhancements is already a significant improvement. Including many of them gives the invention a more user-friendly, useful and polished appearance. This in turn lends itself to a better user experience as well as more users to experience it.

While a preferred embodiment of the invention has been described and illustrated above, other variation may be made utilizing the inventive concepts herein disclosed. The foregoing describes only some embodiments of the invention, and modifications can be made without departing from the scope of the invention as defined in the following claims.

I claim:

1. A method of taking notes of an event on a computerized notetaking device that has a display and at least when needed access to a recording device at least when needed an audio output device, said method comprising the steps of:
(a) said recording device making an audio recording of said event;
(b) said computerized notetaking device inputting notes about said event from a user and inserting these notes into a document and displaying at least a portion of said document on said display and timestamping a plurality of these notes to synchronize them with said audio recording;
(c) said computerized notetaking device, having access to both the audio recording and the notes, inputting a timestamp-selective play command from a user and responsive to the play command, playing said audio recording starting from the selected timestamp's point of synchronization as adjusted by a preplay parameter; and
(d) said computerized notetaking device also performing at least one step selected from the group consisting of the following Arabic-numbered steps:
(1) said computerized notetaking device playing background audio when not playing said audio recording, and additionally responsive to said play command, interrupting the background audio while playing said audio recording;
(2) said computerized notetaking device filtering the recorded audio in the time domain by attempting to find a fundamental frequency that falls in the range of fundamental frequencies of human speech and upon finding any such fundamental frequency, attempting to extract the integral harmonics of this fundamental frequency, the integral harmonics following the fundamental frequency as it varies over time, and retaining only the fundamental frequency and its integral harmonics and short sounds having no fundamental frequency to make the voice of a particular speaker more understandable;
(3) said computerized notetaking device, prior to playing said audio recording starting from a particular point, searching the audio recording for a pause in the sound level of the audio recording that is near said particular point and upon finding such a pause further adjusting said particular point so play starts near the end of said pause that was found;
(4) said computerized notetaking device, when responding to a lockstep play command that is accompanied by a scheduled stop point, searching the audio recording for a pause in the sound level of the audio recording that is near the scheduled stop point and upon finding such a pause stopping audio playback in the pause that was found;
(5) said computerized notetaking device, while inputting notes to a first location, also inputting a next-topic command and responsive to said next-topic command preparing a second location for notes and establishing a timestamp link that does not link to the notes at the first location but rather links to the second location for notes, and after responding to said next-topic command continuing to input notes to the first location; and
(6) said computerized notetaking device, while inputting notes to a first location, also inputting a next-topic command and responsive to said next-topic command preparing a second location for notes and establishing a timestamp link that does not link to the notes at the first location but rather links to the second location for notes and prompting for a next-topic label, and after inputting a termination to the next-topic label displaying the next-topic label at the second location and continuing to input notes to the first location.

2. The method of claim 1 wherein said computerized notetaking device additionally performs a second step chosen from the Arabic-numbered steps, whereby the method comprises two of the Arabic-numbered steps.

3. The method of claim 2 wherein said computerized notetaking device additionally performs a third step chosen from the Arabic-numbered steps, whereby the method comprises three of the Arabic-numbered steps.

4. The method of claim 1 wherein said computerized notetaking device performs all of the Arabic-numbered steps.

5. The method of claim 1 wherein said step of playing said audio recording starting from the selected timestamp's point of synchronization as adjusted by a preplay parameter additionally comprises the steps of playing a predetermined amount of the audio recording at a predetermined maximum speed just prior to the selected timestamp's point of synchronization as adjusted by a preplay parameter and then transitioning to a regular playback speed when substantially at the selected timestamp's point of synchronization as adjusted by a preplay parameter.

6. The method of claim 1 wherein said step of inputting notes comprises inputting keystrokes from a keyboard.

7. The method of claim 1 wherein said step of inputting notes comprises inputting stylus strokes from a pointing device.

8. The method of claim 1—additionally comprising the steps of inputting an insert sidebar box command and responsive to said insert sidebar box command, said computerized notetaking device creating a new text area that is inside said document and that has its own flow of text within said new text area that does not mix with any other flow of text of said document, and displaying said new text area in a box on said display, reflowing any existing notes around the box as necessary, and positioning the caret in the box.

9. The method of claim L additionally comprising the steps of inputting a create callout command accompanied by a choice of target and responsive to said create callout command, said computerized notetaking device preparing an area for explanatory text, placing the caret inside the area for explanatory text and drawing connecting indicia connecting the target and the area for explanatory text.

10. The method of claim 1 additionally comprising the step of said computerized notetaking device attempting speech recognition of the audio recording and generating automatically recognized text that is also linked to said audio recording, and said computerized notetaking device displaying at least a portion of said automatically recognized text in manner that is distinguishable from said notes and said computerized notetaking device inputting a play command that is selective of a portion of said automatically recognized text and responsive to said play command, playing the portion of the audio recording that was linked to said selected portion of said automatically recognized text.

11. The method of claim 1 additionally comprising the step of, further responsive to said step of inputting a timestamp-selective play command, after said step of playing said audio recording starting from the selected timestamp's point of synchronization as adjusted by a preplay parameter, said computerized notetaking device keeping track of the next command and when 67% of the time or more the next command is a rewind command, gradually increasing said preplay parameter and when 67% of the time or more the next command is a fast forward command, gradually reducing said preplay parameter until a predetermined minimum preplay parameter is reached.

12. The method of claim 1 additionally comprising the step of during playing of audio, inputting movements of a scrolling wheel and responsive to these movements rewinding the audio playback for movements in a first direction and fast forwarding the audio playback for movements in a second direction.

13. The method of claim 1 additionally comprising the step of inputting a replay slower command and responsive to each said replay slower command, rewinding the audio by a preconfigured replay amount and reducing the playback speed to a preconfigured replay speed and repeating the just played audio at the preconfigured replay speed, and restoring the previous playback speed when replay is finished.

14. A method of taking notes of an event on a computerized notetaking device that has a display and at least when needed access to a recording device at least when needed an audio output device, said method comprising the steps of:
(a) said recording device making an audio recording of said event;
(b) said computerized notetaking device inputting notes about said event from a user and timestamping a plurality of these notes to synchronize them with said audio recording;
(c) said computerized notetaking device attempting speech recognition of the audio recording so as to generate automatically recognized text that is also linked to said audio recording, and said computerized notetaking device displaying at least a portion of said automatically recognized text in manner that is distinguishable from said notes; and
(d) said computerized notetaking device inputting a play command that is selective of a portion of said automatically recognized text and responsive to said play command, playing the portion of the audio recording that was translated to said selected portion of said automatically recognized text.

15. The method of claim 14 additionally comprising the step of said computerized notetaking device, having access to both the audio recording and the notes, inputting a timestamp-selective play command from a user and responsive to the play command, playing said audio recording starting from the selected timestamp's point of synchronization as adjusted by a preplay parameter;

16. The method of claim 14 additionally comprising the step of said computerized notetaking device inputting a timestamp-selective display command and responsive to said timestamp-selective display command displaying the portion of the automatically recognized text that corresponds to the selected notes.

17. The method of claim 14 wherein during the step of attempting speech recognition, said computerized notetaking device examining said notes and looking for words in said notes that might be correct translates of any portion of the audio recording and whenever any word found in said notes might be a correct translate of a portion of the audio recording, using said word that was found rather than any other potential translates of that portion of the audio recording, thereby increasing the accuracy of the attempted speech recognition.

18. A method of taking notes of an event on a computerized notetaking device that has a display and at least when needed access to a recording device at least when needed an audio output device, said method comprising the steps of:
(a) said recording device making an audio recording of said event;
(b) said computerized notetaking device inputting notes about said event from a user and inserting these notes into a document and displaying at least a portion of said document on said display and timestamping a plurality of these notes to synchronize them with said audio recording;
(c) said computerized notetaking device, having access to both the audio recording and the notes, inputting a timestamp-selective play command from a user and responsive to the play command, playing said audio recording starting from the selected timestamp's point of synchronization as adjusted by a preplay parameter; and
(d) said computerized notetaking device playing background audio when not playing said audio recording, and additionally responsive to said play command, interrupting the background audio while playing said audio recording.

19. A method of taking notes of an event on a computerized notetaking device that has a display and at least when needed access to a recording device at least when needed an audio output device, said method comprising the steps of:
(a) said recording device making an audio recording of said event;
(b) said computerized notetaking device inputting notes about said event from a user and inserting these notes into a document and displaying at least a portion of said document on said display and timestamping a plurality of these notes to synchronize them with said audio recording;
(c) said computerized notetaking device, having access to both the audio recording and the notes, inputting a timestamp-selective play command from a user and responsive to the play command, playing said audio recording starting from the selected timestamp's point of synchronization as adjusted by a preplay parameter; and
(d) said computerized notetaking device, prior to playing said audio recording starting from a particular point, searching the audio recording for a pause in the sound level of the audio recording that is near said particular point and upon finding such a pause further adjusting said particular point so play starts near the end of said pause that was found.

20. The method of claim 19 additionally comprising the step of said computerized notetaking device, when responding to a lockstep play command that is accompanied by a scheduled stop point, searching the audio recording for a pause in the sound level of the audio recording that is near the scheduled stop point and upon finding such a pause stopping audio playback in the pause that was found;

21. A method of taking notes of an event on a computerized notetaking device that has a display and at least when needed access to a recording device at least when needed an audio output device, said method comprising the steps of:
(a) said recording device making an audio recording of said event;
(b) said computerized notetaking device inputting notes about said event from a user and inserting these notes into a document and displaying at least a portion of said document on said display and timestamping a plurality of these notes to synchronize them with said audio recording;
(c) said computerized notetaking device, having access to both the audio recording and the notes, inputting a timestamp-selective play command from a user and responsive to the play command, playing said audio recording starting from the selected timestamp's point of synchronization as adjusted by a preplay parameter; and
(d) said computerized notetaking device, while inputting notes to a first location, also inputting a next-topic command and responsive to said next-topic command preparing a second location for notes and establishing a timestamp link that does not link to the notes at the first location but rather links to the second location for notes, and after responding to said next-topic command continuing to input notes to the first location;

22. The method of claim 21 wherein the step of responding to said next-topic command additionally comprises the steps of prompting for a next-topic label, and after inputting a termination to the next-topic label displaying the next-topic label at the second location and continuing to input notes to the first location.

23. A computerized notetaking device comprising:
(a) notes input means;
(b) display means for displaying notes that were input;
(c) audio recording means for creating an audio recording;
(d) selective audio output means for playing selected portions of the audio recording;
(e) timestamp means for linking a plurality of notes as they are input, each note to a particular point in the audio recording that was recorded about when the note was input, so as to synchronize the notes and the audio recording;
(f) timestamp-selective play command means for inputting a play command that is selective of one of the links between the notes and the audio recording and playing the audio recording starting from a point in the audio recording that was recorded few seconds prior to when the selected link's note was input; and
(g) background audio means for playing background audio when not playing any portion of the audio recording and for allowing the playing of the audio recording to interrupt the playing of background audio.

24. A computerized notetaking device comprising:
(a) notes input means;
(b) display means for displaying notes that were input;
(c) audio recording means for creating an audio recording;
(d) selective audio output means for playing selected portions of the audio recording;
(e) timestamp means for linking a plurality of notes as they are input, each note to a particular point in the audio recording that was recorded about when the note was input, so as to synchronize the notes and the audio recording;
(f) timestamp-selective play command means for inputting a play command that is selective of one of the links between the notes and the audio recording and playing the audio recording starting from a point in the audio recording that was recorded few seconds prior to when the selected link's note was input;
(g) always-on recording means on said device for always recording audio; and
(h) external timestamp button means accessible from the outside of said device for inputting a timestamp command even when the computerized notetaking device is not in use for taking notes.
